(19) United States
(12) Patent Application Publication
(10) Pub. No.: US 2008/0243550 A1
(43) Pub. Date: Oct. 2, 2008

(54) Method and system for organizing, storing, connecting and displaying medical information

(76) Inventor: Robert Y. Yao, Chicago, IL (US)

Correspondence Address: SCHMEISER OLSEN & WATTS, 18 E UNIVERSITY DRIVE, SUITE # 101, MESA, AZ, 85201, US

(21) Appl. No.: 11/732,068

(22) Filed: Apr. 2, 2007

(51) Int. Cl. G06F 19/00; G06Q 90/00

(52) U.S. Cl. 705/3

(57) ABSTRACT

A method and system for organizing, storing connecting and displaying medical information. The methods and system described herein are used for creating an assembly line of information that is used as an operating system for medical and health information. The medical and health information is stored in a hierarchical format. The medical and health information is selected and displayed in one or more display colors to highlight selected components of the displayed information. The method and system is used as a teaching tool, a reference tool, a diagnostic tool for medical professionals and for an information tool for medical patients.

### COPYRIGHT NOTICE

Pursuant to 37 C.F.R. 1.71(e), applicants note that a portion of this disclosure contains material that is subject to and for which is claimed copyright protection, such as, but not limited to, digital photographs, screen shots, user interfaces, or any other aspects of this submission for which copyright protection is or may be available in any jurisdiction. The copyright owner has no objection to the facsimile reproduction by anyone of the patent document or patent disclosure, as it appears in the Patent Office patent file or records. All other rights are reserved, and all other reproduction, distribution, creation of derivative works based on the contents, public display, and public performance of the application or any part thereof are prohibited by applicable copyright law.

### FIELD OF THE INVENTION

This invention relates to health information. More specifically, it relates to a method and system for organizing, storing connecting and displaying medical information.

### BACKGROUND OF THE INVENTION

Medical students are required to learn many different types of information as they progress year-by-year through medical school. New information in a current year typically based on information already learned in a previous year. It is often difficult for medical students to organize, filter and display the information they are required to learn in a coherent manner.

Practicing doctors are typically required to make a diagnosis and suggest a treatment plan (e.g., prescribe medication, etc.) based on a set of patient symptoms, patient history, patient medications, etc. Doctors may consult patient records either on paper or electronically and references such as desk references, on paper or electronically. It is often difficult for doctors to have access to all current information from one place (e.g., a computer terminal) to make a required diagnosis.

Medical patients that have been diagnosed with a current medical condition often would like to be informed about their condition, drugs to treat the condition, treatment drugs interactions with other drugs and other possible courses of actions or treatment plans. It is often difficult for medical patients to have access to medical information from a patient's point of view.

There have been attempts to solve some of the problems with collecting, organizing and displaying medical information. For example, U.S. Pat. No. 7,165,221, entitled “System and method for navigating patient medical information,” Monteleone, et al. teaches “A network compatible user interface system and method are presented for supporting navigation through patient medical information. The system comprises a communication processor for acquiring a patient group identifier allocated to a grouping of patients and for acquiring medical information associated with the patients. A display generator operates to generate a composite display window incorporating a first window including the patient group identifier and a list of patients in the grouping and a second window for displaying different medical information corresponding to different medical applications. The different medical information is associated with patients within the patient grouping. A display navigation processor maintains the first window display while displaying different medical information in the second window in response to user navigation between the different applications.”

U.S. Pat. No. 7,039,878, entitled “Apparatus for processing and displaying patient medical information,” that issued to Auer, et al. teaches “A network compatible, configurable user interface system for displaying a set of user-selectable, sequentially generated patient medical parameters, together with an associated time indication comprises a display menu generator for generating a customization menu that enables user selection of a default set of medical parameters from a plurality of available sets of default medical parameters. The customization menu further enables user modification of the default set of medical parameters. A display generator responsive to a user command operates to display the modified default set of medical parameters in a graphical or tabular format.”

U.S. Pat. No. 6,694,334, entitled “Method and apparatus for displaying medication information,” that issued to DuLong, et al. teaches “A method, system, and article of manufacture for ensuring that the content and appearance of medication information is consistent, accurate, and reliable across multiple hospitals, sites, and users. Publicly available databases provide medication information. Relevant data is extracted from such databases and placed into a drug reference table. The drug reference table is combined with a hospital formulary such that the medication information in the formulary is modified, completed, reformatted, etc. Such modifications, completions, and reformatting are conducted by enforcing one or more rules that are applied to elements and attributes of a medication. The resulting medication information content is stored in a hospital formulary file that is accessed and utilized for maintaining, displaying, administering, etc. medication. To combine the drug reference table with the formulary, a hospital setup tool comprising a graphical user interface that allows a user to approve and finalize medication information may be utilized.”

U.S. Pat. No. 6,434,569, entitled “Integrated medical information system formed of text-based and image-based databases, and display thereof,” that issued to Toshimitsu, et al. teaches “A medical information system has a terminal device of a hospital information system for retrieving and displaying an examination list and a reading report and an image display terminal device for displaying an image. Both terminal devices are arranged to mutually transfer the identification information of an examination to enable their displayed contents to be changed interlockingly. Therefore, medical information, such as charts, medical images, reading reports and results of examinations, required to perform a diagnosis is formed into electronic data and electronic data is displayed on a screen to provide information for a doctor.

U.S. Pat. No. 5,772,585, entitled “System and method for managing patient medical records,” that issued to Lavin, et al. teaches “A system and method for managing patient medical information to facilitate data management and improve physician access to and recordal of examination data is described. The method comprises a computer aided process including the steps of scheduling appointments, entering and displaying data to a physician, updating the patient data with progress notes concurrently with an examination, displaying allergy warnings and recording a diagnosis based on the progress notes. A common graphic user interface is also disclosed to facilitate operation of the preferred system and method. The system and method are implemented with a relational database operating on data tables which store information input into the user interface.”

U.S. Pat. No. 5,447,164, entitled “Interactive medical information display system and method for displaying user-definable patient events,” that issued to Shaya, et al. teaches “An interactive medical information display system and method for displaying user-definable patient events is provided. The system includes a mechanism for acquiring physiological parameters from a patient and a mechanism for storing the parameters in a real-time database. In addition, the system includes a mechanism for users to define event types in an event definition language and a mechanism for users to modify existing event types. Users then select a set of event types for display, and an event generator accesses the database to monitor the physiological parameters in order to detect event occurrences as defined by the event types. A display mechanism displays the event occurrences and provides users with the ability to select event occurrences randomly or sequentially. Upon selection, other information is displayed.”

However, these inventions still do not solve all of the problems associated with collecting, displaying and organizing medical and health information. It is desirable to provide a new method and system for collecting, displaying and organizing medical and health information.

### SUMMARY OF THE INVENTION

In accordance with preferred embodiments of the present invention, some of the problems associated with collecting, displaying and organizing medical information. A method and system for organizing, storing connecting and displaying medical information is presented.

The methods and system described herein are used for creating an assembly line of information that is used as an operating system for medical and health information. The medical and health information is stored in a hierarchical format. The medical and health information is selected and displayed in one or more display colors to highlight selected components of the displayed information. The method and system is used as a teaching tool, a reference tool, a diagnostic tool for medical professionals and for an information tool for medical patients.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating a medical information display system;

FIG. 2 is a block diagram illustrating an exemplary universal health information template for organizing health information;

FIG. 3 is a block diagram illustrating an exemplary universal health information template for organizing health information;

FIG. 4 is a flow diagram illustrating a method for organizing health information;

FIG. 5 is a flow diagram illustrating a method for displaying health information;

FIG. 6 is a block diagram illustrating a first set of health information related to cardiology;

FIG. 7 is a block diagram illustrating a second set of health information related to cardiology;

FIG. 8 is a block diagram illustrating a third set of health information related to cardiology;

FIG. 9 is block diagram illustrating a fourth set of health information related to cardiology;

FIG. 10 is a block diagram illustrating immunology information;

FIG. 11 is a block diagram illustrating immunology pathways;

FIG. 12 is a flow diagram illustrating a method for displaying medical information;

FIG. 13 is a block diagram illustrating an exemplary three-dimensional view of an exemplary patient on a graphical user interface;

FIG. 14 is a block diagram illustrating exemplary cardiology information;

FIG. 15 is a block diagram illustrating exemplary additional cardiology information at a lower level-X in the information hierarchy; and

FIG. 16 is a block diagram illustrating exemplary additional cardiology information at a lower level-X+1 in the information hierarchy.

### DETAILED DESCRIPTION OF THE INVENTION

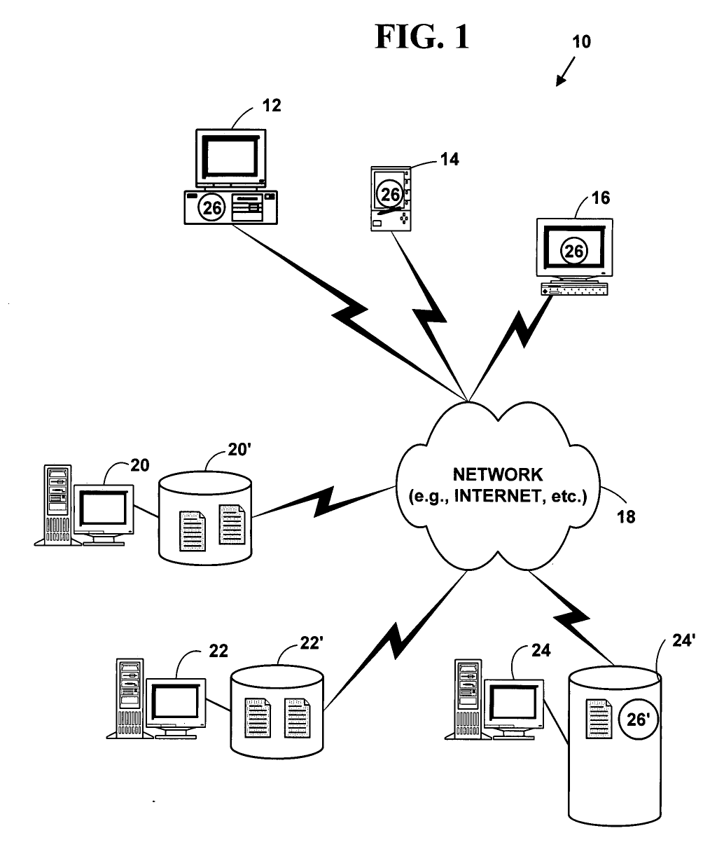

FIG. 1 is a block diagram illustrating an exemplary medical information display system 10 for electronic devices. The exemplary system 10 includes, but is not limited to, one or more target devices 12, 14, 16 (only three of which are illustrated). However, the present invention is not limited to these target electronic devices and more, fewer or others types of target electronic devices can also be used. The target devices 12, 14, 16 are in communications with a communications network 18. The communications includes, but is not limited to, communications over a wire connected to the target network devices, wireless communications, and other types of communications using one or more communications and/or networking protocols.

Plural server devices 20, 22, 24 (only three of which are illustrated) include one or more associated databases 20′, 22′, 24′. The plural network devices 20, 22, 24 are in communications with the one or more target devices 12, 14, 16 via the communications network 18. The plural server devices 20, 22, 24, include, but are not limited to, World Wide Web servers, Internet servers, file servers, other types of electronic information servers, and other types of server network devices (e.g., edge servers, firewalls, routers, gateways, etc.).

The plural server devices 20, 22, 24 include, but are not limited to, servers used for storing electronic medical information for users of target devices 12, 14, 16. The one or more associated databases 20, 22, 24 include electronic information in plural digital formats, including, but not limited to, Hyper Text Markup Language (HTML), Extensible Markup Language (XML), other mark-up languages, Wireless Access Protocol (WAP), flash media, Java and various combinations thereof.

The one or more target devise 12, 14, 16 and the plural server devices 20, 22, 24 may include a training application 26. The training application 26 may be a stand-alone application 26 or networking applications 26′ that communicates with other networking applications 26′ via the communications network 18.

In applications 26, 26′ include, software, hardware (e.g., ROM, Flash, etc.) firmware or other types of applications such as DVD's, audio files, video files, etc.

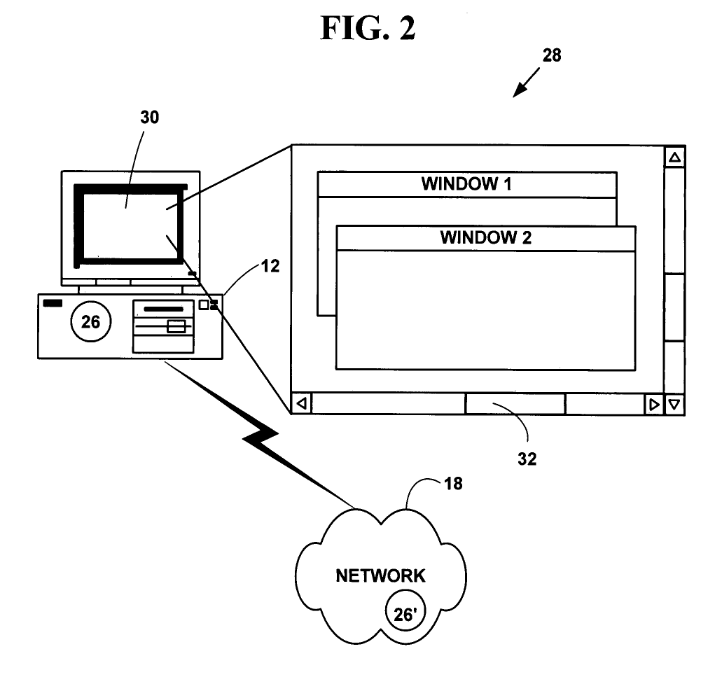

FIG. 2 is a block diagram illustrating an exemplary health information display system 28. The exemplary electronic trading system display system includes, but is not limited to a target device (e.g., 12) with a display 30. The target device includes an application 26 that presents a graphical user interface (GUI) 32 on the display 28. The GUI 32 presents a multi-window interface to a user.

The target devices 12, 14, 16 include a protocol stack with multiple layers based on the OSI reference model or the Internet reference model.

As is known in the art, the Open Systems Interconnection (“OSI”) reference model is a layered architecture that standardizes levels of service and types of interaction for network devices exchanging information through a communications network. The OSI reference model separates network device-to-network device communications into seven protocol layers, or levels, each building-and relying--upon the standards contained in the levels below it. The OSI reference model includes from lowest-to-highest, a physical, data-link, network, transport, session, presentation and application layer. The lowest of the seven layers deals solely with hardware links; the highest deals with software interactions at the application-program level.

As is known in the art, the Internet reference model is a layered architecture that standardizes levels of service for the Internet Protocol suite of protocols. The Internet reference model comprises in general from lowest-to-highest, a link, network, transport and application layer.

The one or more target devices 12, 14, 16 include, but are not limited to, personal digital/data assistants (PDAs), laptop computers, mobile computers, desktop computers, Internet appliances, portable audio devices, (e.g., MP3 players, etc.) video cameras, set-top boxes, digital video recorders, one or two-way pagers, mobile phones, non-mobile phones, Internet phones, personal communications devices or other similar desktop, mobile non-mobile electronic devices. Other or equivalent devices can also be used to practice the invention. The target devices 12, 14, 16, may also be replaced with other types of devices including, but not limited to, client terminals in communications with one or more servers, other types of electronic devices.

The communications network 18 includes, but is not limited to, the Internet, an intranet, a wired Local Area Network (LAN), a wireless LAN (WiLAN), a Wide Area Network (WAN), a Metropolitan Area Network (MAN), a Public Switched Telephone Network (PSTN) and other types of communications networks 18.

The communications network 18 may include one or more gateways, routers, or bridges. As is known in the art, a gateway connects computer networks using different network protocols and/or operating at different transmission capacities. A router receives transmitted messages and forwards them to their correct destinations over the most efficient available route. A bridge is a device that connects networks using the same communications protocols so that information can be passed from one network device to another.

The communications network 18 may include one or more servers and one or more web-sites accessible by users to send and receive information useable by the one or more computers 12. The one or more servers may also include one or more associated databases for storing electronic information.

Preferred embodiments of the present invention include network devices that are compliant with all or part of standards proposed by the Institute of Electrical and Electronic Engineers (“IEEE”), International Telecommunications Union-Telecommunication Standardization Sector (“ITU”), European Telecommunications Standards Institute (ETSI), Internet Engineering Task Force (“IETF”), U.S. National Institute of Security Technology (“NIST”), American National Standard Institute (“ANSI”), Wireless Application Protocol (“WAP”) Forum, Data Over Cable Service Interface Specification (DOCSIS), Bluetooth Forum, or the ADSL Forum. However, network devices based on other standards could also be used. IEEE standards can be found on the World Wide Web at the Universal Resource Locator (“URL”) “www.ieee.org.” The ITU, (formerly known as the CCITT) standards can be found at the URL “www.itu.ch.” ETSI standards can be found at the URL “www.etsi.org.” IETF standards can be found at the URL “www.ietf.org.” The NIST standards can be found at the URL “www.nist.gov.” The ANSI standards can be found at the URL “www.ansi.org.” DOCSIS documents can be found at the URL “www.cablemodem.com.” Bluetooth Forum documents can be found at the URL “www.bluetooth.com.” WAP Forum documents can be found at the URL “www.wapforum.org.” ADSL Forum documents can be found at the URL “www.adsl.com.”

The communications network 18 includes, but is not limited to, data networks using the Transmission Control Protocol (TCP), User Datagram Protocol (UDP), Internet Protocol (IP) and other data protocols.

As is know in the art, TCP provides a connection-oriented, end-to-end reliable protocol designed to fit into a layered hierarchy of protocols which support multi-network applications. TCP provides for reliable inter-process communication between pairs of processes in network devices attached to distinct but interconnected networks. For more information on TCP see Internet Engineering Task Force (ITEF) Request For Comments (RFC)-793, the contents of which are incorporated herein by reference.

As is known in the art, UDP provides a connectionless mode of communications with datagrams in an interconnected set of computer networks. UDP provides a transaction oriented datagram protocol, where delivery and duplicate packet protection are not guaranteed. For more information on UDP see IETF RFC-768, the contents of which incorporated herein by reference.

As is known in the art, IP is an addressing protocol designed to route traffic within a network or between networks. IP is described in IETF Request For Comments (RFC)-791, the contents of which are incorporated herein by reference. However, more fewer or other protocols can also be used on the communications network 18 and the present invention is not limited to TCP/UDP/IP.

In one embodiment, the communications network 18 includes wired interfaces connecting portions of a PSTN or cable television network that connect the target devices 12, 14, 16 via one or more twisted pairs of copper wires including the varieties of digital subscriber line (DSL), coaxial cable, fiber optic cable, other connection media or other connection interfaces. The PSTN is any public switched telephone network provided by AT&T, GTE, Sprint, MCI, SBC, Verizon and others.

In another embodiment, the communications network 18 includes one or more different types of wireless interfaces that connect the target devices 12, 14, 16 wirelessly to communications network 18. The wireless interfaces include but are not limited to, an IEEE 802.11a, 802.11b, 802.11g, 802.11n, “Wireless Fidelity” (“Wi-Fi”), “Worldwide Interoperability for Microwave Access” (“WiMAX”), ETSI High Performance Radio Metropolitan Area Network (HIPERMAN). In another embodiment of, the wireless interfaces Bluetooth (IEEE 802.15.1a) infra data association (IrDA) module or Industrial, Scientific and Medical (ISM) 400 MHz, 800 MHz, and 900 Mhz wireless interfaces. However, the present invention is not limited to such an embodiment and other types wireless interfaces can also be used.

As is known in the art, an 802.11b is a short-range wireless network. The IEEE 802.11b standard defines wireless interfaces that provide up to 11 Mbps wireless data transmission to and from wireless devices over short ranges. 802.11a is an extension of the 802.11b and can deliver speeds up to 54M bps. 802.11g deliver speeds on par with 802.11a. However, other 802.11XX interfaces can also be used and the present invention is not limited to the 802.11 protocols defined. The IEEE 802.11a, 802.11b and 802.11g standards are incorporated herein by reference.

As is known in the art, Wi-Fi is a type of 802.11XX interface, whether 802.11b, 802.11a, dual-band, etc. Wi-Fi devices include an RF interfaces such as 2.4 GHz for 802.11b or 802.11g and 5 GHz for 802.11a. More information on Wi-Fi can be found at the URL www.weca.net.

As is known in the art, WiMAX is an industry trade organization formed by leading communications component and equipment companies to promote and certify compatibility and interoperability of broadband wireless access equipment that conforms to the IEEE 802.16XX and ETSI HIPERMAN. HIPERMAN is the European standard for metropolitan area networks (MAN).

The IEEE The 802.16a and 802.16g standards are wireless MAN technology standard that provides a wireless alternative to cable, DSL and T1/E1 for last mile broadband access. It is also used as complimentary technology to connect IEEE 802.11XX hot spots to the Internet.

The IEEE 802.16a standard for 2-11 GHz is a wireless MAN technology that provides broadband wireless connectivity to fixed, portable and nomadic devices. It provides up to 50-kilometers of service area range, allows users to get broadband connectivity without needing direct line of sight with the base station, and provides total data rates of up to 280 Mbps per base station, which is enough bandwidth to simultaneously support hundreds of businesses with T1/E1-type connectivity and thousands of homes with DSL-type connectivity with a single base station. The IEEE 802.16g provides up to 100 Mbps.

The IEEE 802.16e standard is an extension to the approved IEEE 802.16/16a/16g standard. The purpose of 802.16e is to add limited mobility to the current standard which is designed for fixed operation.

The ESTI HIPERMAN standard is an interoperable broadband fixed wireless access standard for systems operating at radio frequencies between 2 GHz and 11 GHz.

The IEEE 802.16a, 802.16e and 802.16g standards are incorporated herein by reference. More information on WiMAX can be found at the URL “www.wimaxforum.org.” WiMAX can be used to provide a WLP.

The ETSI HIPERMAN standards TR 101 031, TR 101 475, TR 101 493-1 through TR 101 493-3, TR 101 761-1 through TR 101 761-4, TR 101 762, TR 101 763-1 through TR 101 763-3 and TR 101 957 are incorporated herein by reference. More information on ETSI standards can be found at the URL “www.etsi.org.” ETSI HIPERMAN can be used to provide a WLP.

An operating environment for the devices of the exemplary system 10 include a processing system with one or more high speed Central Processing Unit(s) (“CPU”), processors and one or more memories. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It will be appreciated that acts and symbolically represented operations or instructions include the manipulation of electrical signals by the CPU or processor. An electrical system represents data bits which cause a resulting transformation or reduction of the electrical signals or biological signals, and the maintenance of data bits at memory locations in a memory system to thereby reconfigure or otherwise alter the CPU's or processor's operation, as well as other processing of signals. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., Random Access Memory (“RAM”)) or non-volatile (e.g., Read-Only Memory (“ROM”), flash memory, etc.) mass storage system readable by the CPU. The computer readable medium includes cooperating or interconnected computer readable medium, which exist exclusively on the processing system or can be distributed among multiple interconnected processing systems that may be local or remote to the processing system.

### Security and Encryption

Devices and interfaces of the present invention include security and encryption for secure communications and secure recording, transmission and display of medical information. Privacy is required for certain types of medical information collected, stored and displayed for medical patients. For example, in association with the Health Insurance Portability and Accountability Act of 1996 (HIPAA), the U.S. Department of Health and Human Services (HHS) issued the regulations Standards for Privacy of Individually Identifiable Health Information. For most covered entities, compliance with these regulations, known as the “Privacy Rule,” was required as of Apr. 14, 2003). The security and encryption described herein is used to protect such privacy.

Wireless Encryption Protocol (WEP) (also called “Wired Equivalent Privacy) is a security protocol for WiLANs defined in the IEEE 802.11b standard. WEP is cryptographic privacy algorithm, based on the Rivest Cipher 4 (RC4) encryption engine, used to provide confidentiality for 802.11b wireless data.

As is known in the art, RC4 is cipher designed by RSA Data Security, Inc. of Bedford, Mass., which can accept encryption keys of arbitrary length, and is essentially a pseudo random number generator with an output of the generator being XORed with a data stream to produce encrypted data.

One problem with WEP is that it is used at the two lowest layers of the OSI model, the physical layer and the data link layer, therefore, it does not offer end-to-end security. One another problem with WEP is that its encryption keys are static rather than dynamic. To update WEP encryption keys, an individual has to manually update a WEP key. WEP also typically uses 40-bit static keys for encryption and thus provides “weak encryption,” making a WEP device a target of hackers.

The IEEE 802.11 Working Group is working on a security upgrade for the 802.11 standard called “802.11i.” This supplemental draft standard is intended to improve WiLAN security. It describes the encrypted transmission of data between systems 802.11X WiLANs. It also defines new encryption key protocols including the Temporal Key Integrity Protocol (TKIP). The IEEE 802.11i draft standard, version 4, completed Jun. 6, 2003, is incorporated herein by reference.

The 802.11i is based on 802.1x port-based authentication for user and device authentication. The 802.11i standard includes two main developments: Wireless or Wi-Fi Protected Access (WPA) and Robust Security Network (RSN).

WPA uses the same RC4 underlying encryption algorithm as WEP. However, WPA uses TKIP to improve security of keys used with WEP. WPA keys are derived and rotated more often than WEP keys and thus provide additional security. WPA also adds a message-integrity-check function to prevent packet forgeries.

RSN uses dynamic negotiation of authentication and selectable encryption algorithms between wireless access points and wireless devices. The authentication schemes proposed in the draft standard include Extensible Authentication Protocol (EAP). One proposed encryption algorithm is an Advanced Encryption Standard (AES) encryption algorithm.

Dynamic negotiation of authentication and encryption algorithms lets RSN evolve with the state of the art in security, adding algorithms to address new threats and continuing to provide the security necessary to protect information that WiLANs carry.

The NIST developed a new encryption standard, the Advanced Encryption Standard (AES) to keep government information secure. AES is intended to be a stronger, more efficient successor to Triple Data Encryption Standard (3DES). More information on NIST AES can be found at the URL “www.nist.gov/aes.”

As is known in the art, DES is a popular symmetric-key encryption method developed in 1975 and standardized by ANSI in 1981 as ANSI X.3.92, the contents of which are incorporated herein by reference. As is known in the art, 3DES is the encrypt-decrypt-encrypt (EDE) mode of the DES cipher algorithm. 3DES is defined in the ANSI standard, ANSI X9.52-1998, the contents of which are incorporated herein by reference. DES modes of operation are used in conjunction with the NIST Federal Information Processing Standard (FIPS) for data encryption (FIPS 46-3, October 1999), the contents of which are incorporated herein by reference.

The NIST approved a FIPS for the AES, FIPS-197. This standard specified “Rijndael” encryption as a FIPS-approved symmetric encryption algorithm that may be used by U.S. Government organizations (and others) to protect sensitive information. The NIST FIPS-197 standard (AES FIPS PUB 197, November 2001) is incorporated herein by reference.

The NIST approved a FIPS for U.S. Federal Government requirements for information technology products for sensitive but unclassified (SBU) communications. The NIST FIPS Security Requirements for Cryptographic Modules (FIPS PUB 140-2, May 2001) is incorporated herein by reference.

As is known in the art, RSA is a public key encryption system which can be used both for encrypting messages and making digital signatures. The letters RSA stand for the names of the inventors: Rivest, Shamir and Adleman. For more information on RSA, see U.S. Pat. No. 4,405,829, now expired, incorporated herein by reference.

As is known in the art, “hashing” is the transformation of a string of characters into a usually shorter fixed-length value or key that represents the original string. Hashing is used to index and retrieve items in a database because it is faster to find the item using the shorter hashed key than to find it using the original value. It is also used in many encryption algorithms.

Secure Hash Algorithm (SHA), is used for computing a secure condensed representation of a data message or a data file. When a message of any length <2⁶⁴ bits is input, the SHA-1 produces a 160-bit output called a “message digest.” The message digest can then be input to other security techniques such as encryption, a Digital Signature Algorithm (DSA) and others which generates or verifies a security mechanism for the message. SHA-512 outputs a 512-bit message digest. The Secure Hash Standard, FIPS PUB 180-1, Apr. 17, 1995, is incorporated herein by reference.

Message Digest-5 (MD-5) takes as input a message of arbitrary length and produces as output a 128-bit “message digest” of the input. The MD5 algorithm is intended for digital signature applications, where a large file must be “compressed” in a secure manner before being encrypted with a private (secret) key under a public-key cryptosystem such as RSA. The IETF RFC-1321, entitled “The MD5 Message-Digest Algorithm” is incorporated here by reference.

As is known in the art, providing a way to check the integrity of information transmitted over or stored in an unreliable medium such as a wireless network is a prime necessity in the world of open computing and communications. Mechanisms that provide such integrity check based on a secret key are called “message authentication codes” (MACS). Typically, message authentication codes are used between two parties that share a secret key in order to validate information transmitted between these parties.

Keyed Hashing for Message Authentication Codes (HMAC), is a mechanism for message authentication using cryptographic hash functions. HMAC is used with any iterative cryptographic hash function, e.g., MD5, SHA-1, SHA-512, etc. in combination with a secret shared key. The cryptographic strength of HMAC depends on the properties of the underlying hash function. The IETF RFC-2101, entitled “HMAC: Keyed-Hashing for Message Authentication” is incorporated here by reference.

As is known in the art, an Electronic Code Book (ECB) is a mode of operation for a “block cipher,” with the characteristic that each possible block of plaintext has a defined corresponding cipher text value and vice versa. In other words, the same plaintext value will always result in the same cipher text value. Electronic Code Book is used when a volume of plaintext is separated into several blocks of data, each of which is then encrypted independently of other blocks. The Electronic Code Book has the ability to support a separate encryption key for each block type.

As is known in the art, Diffie and Hellman (DH) describe several different group methods for two parties to agree upon a shared secret in such a way that the secret will be unavailable to eavesdroppers. This secret is then converted into various types of cryptographic keys. A large number of the variants of the DH method exist including ANSI X9.42. The IETF RFC-2631, entitled “Diffie-Hellman Key Agreement Method” is incorporated here by reference.

However, the present invention is not limited to the security or encryption techniques described and other security or encryption techniques can also be used.

As is known in the art, the HyperText Transport Protocol (HTTP) Secure (HTTPs), is a standard for encrypted communications on the World Wide Web. HTTPs is actually just HTTP over a Secure Sockets Layer (SSL). For more informaiton on HTTP, see IETF RFC-2616 incorporated herein by reference.

As is known in the art, the SSL protocol is a protocol layer which may be placed between a reliable connection-oriented network layer protocol (e.g. TCP/IP) and the application protocol layer (e.g. HTTP). SSL provides for secure communication between a source and destination by allowing mutual authentication, the use of digital signatures for integrity, and encryption for privacy.

The SSL protocol is designed to support a range of choices for specific security methods used for cryptography, message digests, and digital signatures. The security method are negotiated between the source and destination at the start of establishing a protocol session. The SSL 2.0 protocol specification, by Kipp E. B. Hickman, 1995 is incorporated herein by reference. More information on SSL is available at the URL See “netscape.com/eng/security/SSL_{—}2.html.”

As is known in the art, Transport Layer Security (TLS) provides communications privacy over the Internet. The protocol allows client/server applications to communicate over a transport layer (e.g., TCP) in a way that is designed to prevent eavesdropping, tampering, or message forgery. For more information on TLS see IETF RFC-2246, incorporated herein by reference.

In one embodiment, the security functionality includes Cisco Compatible EXtensions (CCX). CCX includes security specifications for makers of 802.11xx wireless LAN chips for ensuring compliance with Cisco's proprietary wireless security LAN protocols. As is known in the art, Cisco Systems, Inc. of San Jose, Calif. is supplier of networking hardware and software, including router and security products.

### Organizing Health Information

In one embodiment, a universal health information template is used for organizing health information. The health information includes, but is not limited to, biological, medical, clinical and pharmacological information organized with a hierarchical structure.

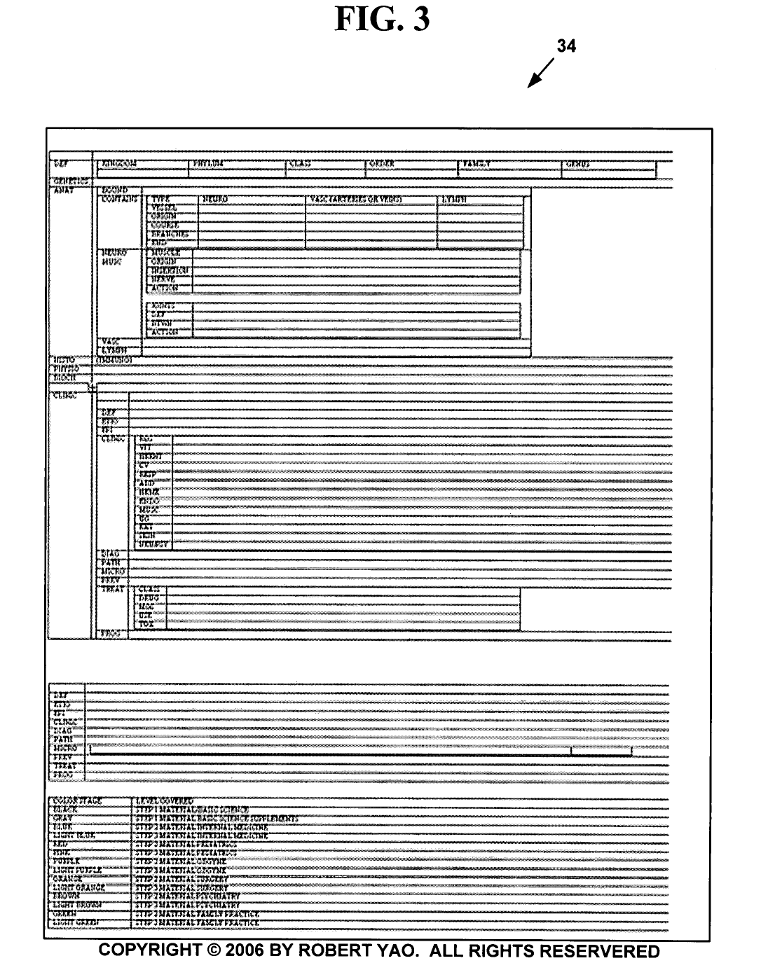

FIG. 3 is a block diagram 34 illustrating an exemplary universal health information template 36 for organizing health information. The universal health information template includes defining a kingdom, phylum, class, order, family and genus of health information at a level-X in a hierarchical structure with N-layers. The template 36 further includes defining a genetic, anatomical, histological, physiological, biochemical, clinical, and pharmacological information at a level X+1 to level X+Y. The template 36 further includes a set of pre-defined set of plural colors for displaying the health information on a multi-windowed graphical user interface (GUI) at a level Y+1. ever, the present invention is not limited to such an embodiment or hierarchy and other embodiments and hierarchies can also be used to practice the invention.

In another embodiment, the universal health information includes defining a kingdom, phylum, class, order and family. In such an embodiment, the universal health template is used for organisms other than human beings. In such an embodiment, not all of the information collected for a human would be collected for a non-human biological organisms.

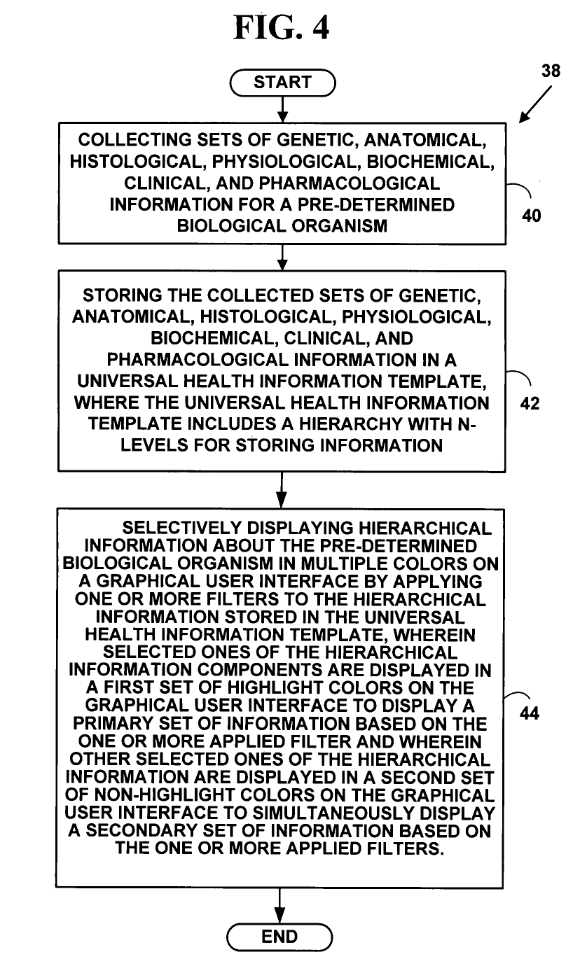

FIG. 4 is a flow diagram illustrating a Method 38 for organizing health information. At Step 40, sets of genetic, anatomical, histological, physiological, biochemical, clinical, and pharmacological information are collected for a pre-determined biological organism. At Step 42, the collected sets of genetic, anatomical, histological, physiological, biochemical, clinical, and pharmacological information are stored in a universal health information template. The universal health information template includes a hierarchy with N-levels for storing information. At Step 44, the universal health information template is used to selectively display hierarchical information about the pre-determined biological organism in multiple colors on a graphical user interface by applying one or filters to the hierarchical information. Selected ones of the hierarchical information components are displayed in a first set of highlight colors on the graphical user interface to display a primary set of information based on the one or more applied filter. Other selected ones of the hierarchical information are displayed in a second set of non-highlight colors on the graphical user interface to simultaneously display a secondary set of information based on the one or more applied filters.

Method 38 is illustrative with an exemplary embodiment. However, the present invention is not limited to such an embodiment and other embodiments can also be used to practice the invention.

In such an exemplary embodiment at Step 40, sets of genetic, anatomical, histological, physiological, biochemical, clinical, and pharmacological information are collected for a pre-determined biological organism. For example, the sets of information are collected for a human, for a mammal, etc. In one embodiment, the sets of information include generic information that can be applied to the pre-determined organism in general. In another embodiment, addition sets of information for a specific pre-determined biological organism are collected as well. However, the present invention is not limited to this embodiment and other embodiments can also be used to practice the invention.

For example, for a human patient, sets of genetic, anatomical, histological, physiological, biochemical, clinical, and pharmacological information are collected that will apply to all human beings. In addition, sets of genetic (e.g., DNA, etc.), anatomical histological, physiological, biochemical, clinical (e.g., blood tests, x-rays, MRIs, CAT and PET scans, etc.), and pharmacological (e.g., prescriptions, vitamins, herbal supplements, other supplements, etc.) information specifically for the human patient are collected. This information was determined during medical examinations and medical laboratory tests conducted on the human patient.

In another embodiment, for organisms other than human beings, other types of information are collected. In such an embodiment information is collected that will apply to the selected organism.

At Step 42, the collected sets of genetic, anatomical, histological, physiological, biochemical, clinical, and pharmacological information are stored in the universal health information template 36. The universal health information template includes a hierarchy with N-levels for storing information. The universal health information template 36 is then stored in one or more databases 20′, 22′, 24′ associated with the server devices 20, 22, 24. The universal health information template 36 may be stored locally on a target device 12, 14, 16 or remotely on a server device 20, 22, 24 via the communications network 18.

At Step 44, the universal health information template 36 is used to selectively display hierarchical information about the pre-determined biological organism in multiple colors on a GUI 32 by applying one or more filters to the hierarchical information. Selected ones of the hierarchical information components are displayed in a first set of highlight colors on the graphical user interface to display a primary set of information based on the one or more applied filter. Other selected ones of the hierarchical information are displayed in a second set of non-highlight colors on the graphical user interface to simultaneously display a secondary set of information based on the one or more applied filters.

For example, the one or more filters include, but are not limited to, a current a selected type of information (e.g., drugs used to treat a current medical condition, etc.), medical condition (e.g., chest pains and trouble breathing), a selected type of information based on a prior knowledge level (e.g., medical doctor, patient, knowledge requirements for a first year medical student to pass exams, etc.), a pre-determined logic association (e.g. side affects of all herbal supplements and vitamins that affect memory retention, etc.).

In one embodiment, the one or more filters are created by selecting one or more items from a menu displayed on the GUI 32. For example, the menu items may include, specific items for a patient, practicing physician, 1^{st} year medical student, 2^{nd} year medical student, resident, researcher, etc.

For example, if a user selected a menu option for a 2^{nd} year medical student, a first set of highlight colors (e.g. red, orange, yellow, etc.) is used to display on the GUI 32 required knowledge to pass exams for a 1^{st} year medical student and a second set of non-highlight colors (e.g., blue, green, purple, etc.) is used to display required for a 2^{nd} year medical student. In such an embodiment, a 2^{nd} year medical student can quickly and easily determine what additional information is required for a 2^{nd} year medical student to learn to pass exams. In addition, in such an embodiment the 2^{nd} year medical student can also determine what additional knowledge was required to learn between the 1^{st} and 2^{nd} year of medical school. In another embodiment, only information required to pass exams for a 2^{nd} year medical student is required in one single highlight color (e.g., red, etc.).

In addition, a medical student or other health practitioner can also filter the information displayed based on information content, information source or medical specialty. For example, a cardiologist can filter the information to include only information related to cardiology, (or embryologic, obstetric, pediatric, gynecologic, psychiatric or nuerologic areas of medicine).

In another example, if a user selected a menu option for a patient, then the patient's individual medical information would be displayed on the GUI 32 as well medical information at a level a patient (i.e., instead of a medical student or practicing physician) would understand in multiple colors. In this example, menu options for a patient help educate a patient of current or chronic medical conditions.

In one embodiment, a user can define his/her own filters to selectively display desired types of information. The desired information is displayed in multiple colors (highlighted and non-highlighted colors) on the GUI 32. For example, a user as a patient may desire create a filter to display all medical information and treatment options about a specific disease based on their own current medical condition and clinical laboratory data.

### Displaying Health Information

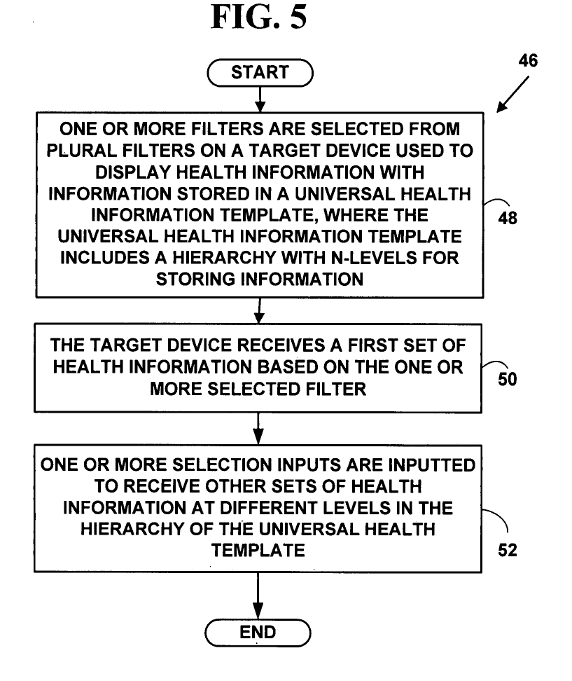

FIG. 5 is a flow diagram illustrating a Method 46 for displaying health information. At Step 48, one or more filters are selected from plural filters on a target device used to display health information with information stored in a universal health information template. The universal health information template includes a hierarchy with N-levels for storing information. At Step 50, target device receives a first set of health information based on the one or more selected filters. At Step 52, one or more selection inputs are inputted to receive other sets of health information at different levels in the hierarchy of the universal health template.

Method 46 is illustrative with an exemplary embodiment. However, the present invention is not limited to such an embodiment and other embodiments can also be used to practice the invention.

In such an exemplary embodiment at Step 48, one or more filters are selected from plural filters on a target device 12, 14, 16 used to display health information with information stored in a universal health information template 36. The universal health information template 36 includes a hierarchy with N-levels for storing information. For example, a user who is a practicing physician may selected a filter called “physician.” This doctor has a patient with chest pains and a history of heart problems. So a second filter called “cardiology” is selected.

In another embodiment, the one or more filters are selected based on use. For practical clinical purposes, this can include specialty “cardiologist versus neurologist” or “date” and can be applied to the SOAP notes or H & Ps for a patient to view records of various specialties on various dates or can be applied as a reference. This reference is used to filter through the selected information to illustrate what each particular doctor or “gold standard” textbooks (e.g., Harrison's vs “Cecil's” in the case of Internal Medicine or either vs “Nelson's” in the case of pediatrics) or other standard for textbooks in various different or similar specialties would have knowledge wise when creating the H&P or SOAP notes.

As is known in the medical arts, SOAP stands for the major categories included within patient notes including Subjective information, Objective data, Assessment, and Plan. As is known in the medical arts, H&P stands for History and Physical notes collected for a patient.

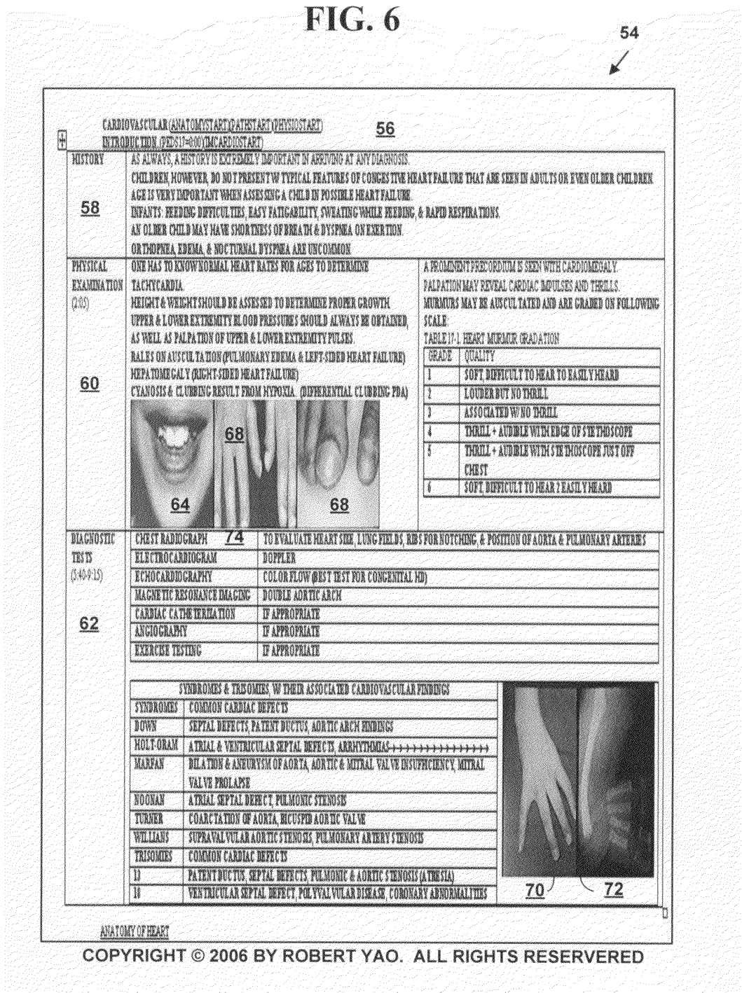

At Step 50, the target device 12, 14, 16 receives a first set of health information based on the one or more selected filters. For example, the system 10 may display a first set of exemplary health information as is illustrated in FIG. 6.

FIGS. 6-10 illustrate actual screen shots of displayed on GUI 32 by system 10. Further details of these information display screens is presented below.

FIG. 6 is a block diagram 54 illustrating a first set of health information related to cardiology 56. The cardiology information includes a first portion 58 related to collecting a medical history for a patient. A second portion 60 related to physical examination techniques related to cardiology. A third portion 62 related to diagnostic tests for cardiology. The cardiology information includes teaching photographs 64-70 and teaching x-rays 72 illustrating symptoms and syndromes associated with the cardiovascular system. Selecting the photographs also displays video and audio files associated with the topic in the photograph. For example, selecting photograph 70 allows a physician to watch a video or hear a lecture of symptoms and conditions associated with cyanosis and clubbing resulting from hypoxia. Selecting photograph 70 also allows a physician to access current medical research associated with such symptoms and conditions. In this example, the information displayed on this output screen at a level X in the information hierarchy.

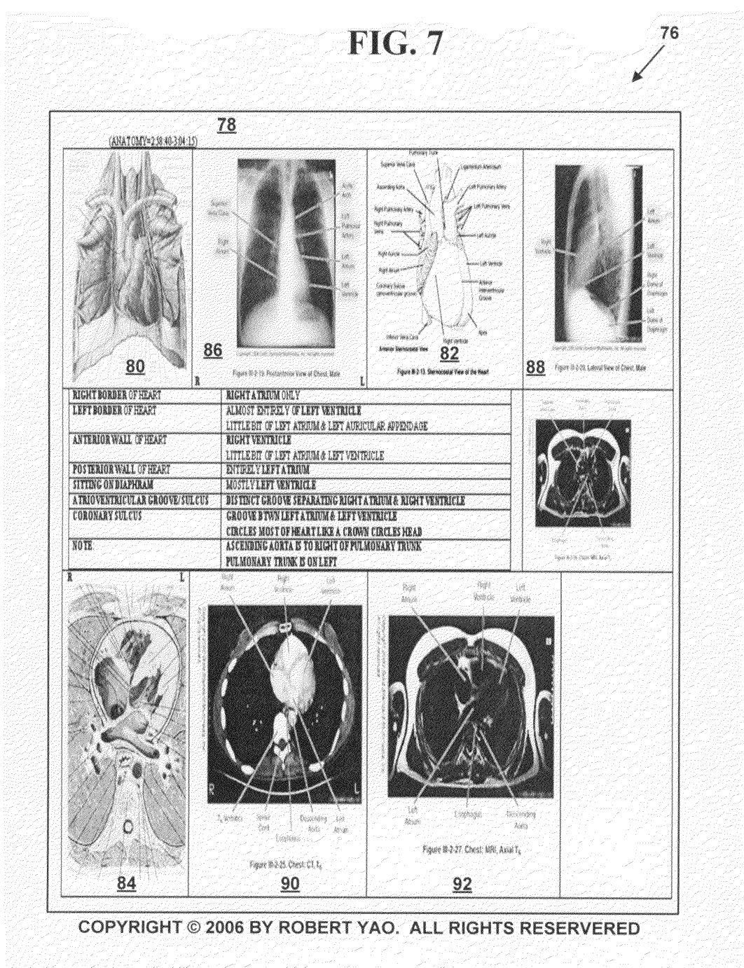

At Step 52, one or more selection inputs are inputted to receive other sets of health information at different levels in the hierarchy of the universal health template 36. The selection inputs may be received by selecting text, graphics, multimedia or other types of displayed information. For example, if the physician clicked on box 74 for chest radiograph, a second set of information is displayed as is illustrated in FIG. 7. In this example, the information displayed on this output screen at a level X+1 in the information hierarchy.

FIG. 7 is a block diagram 76 illustrating a second set of health information related to radiograph cardiology 78. This second set of information includes anatomical drawings 80-84, x-rays 86-88, chest CAT scans 90, chest MRI 92 and other type of cardiac information. In FIG. 7, the x-rays and other scan images include general images used for teaching and information purposes. The x-rays and other scan images are then used to compare the collected information with stored information, diagramed models and with verbal descriptions.

In one embodiment, such x-rays and scan images include actual x-rays are images collected, stored and displayed for a specific patient. In such an embodiment, the patient may have cardiovascular disease and the physician uses the system 10 to review prior tests results and medical records. The patient data and other information displayed are also cross referenced to various layers of expert opinions or gold standard textbooks.

In another embodiment, a full body scan is completed on a patient. Various tags are placed on the full body scan. When the tags are selected individual x-rays, CAT scans, MRIs, etc. are displayed for the patent.

For example, if the physician clicked on box 80 a graphical heart diagram, a third set of information is displayed as is illustrated in FIG. 7. The information displayed on this output screen is at a level X+1 in the information hierarchy.

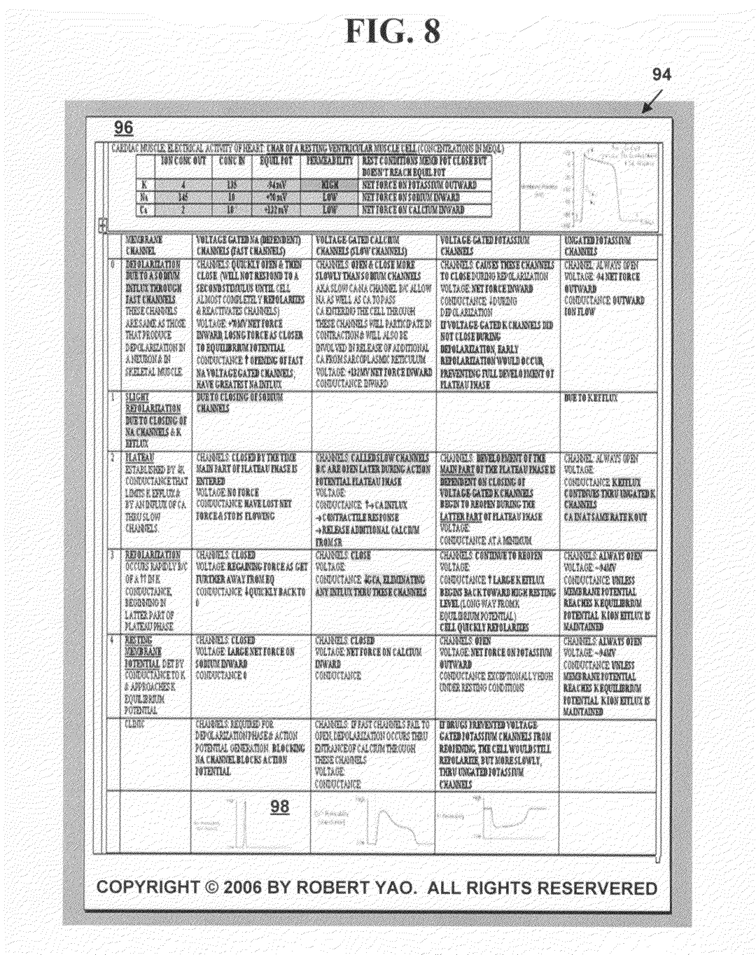

FIG. 8 is a block diagram 94 illustrating a third set of health information related to cardiology 96. FIG. 8 represents the physiology of the heart's electrical function. In this example, the information displayed on this output screen is at a level X+2 in the information hierarchy.

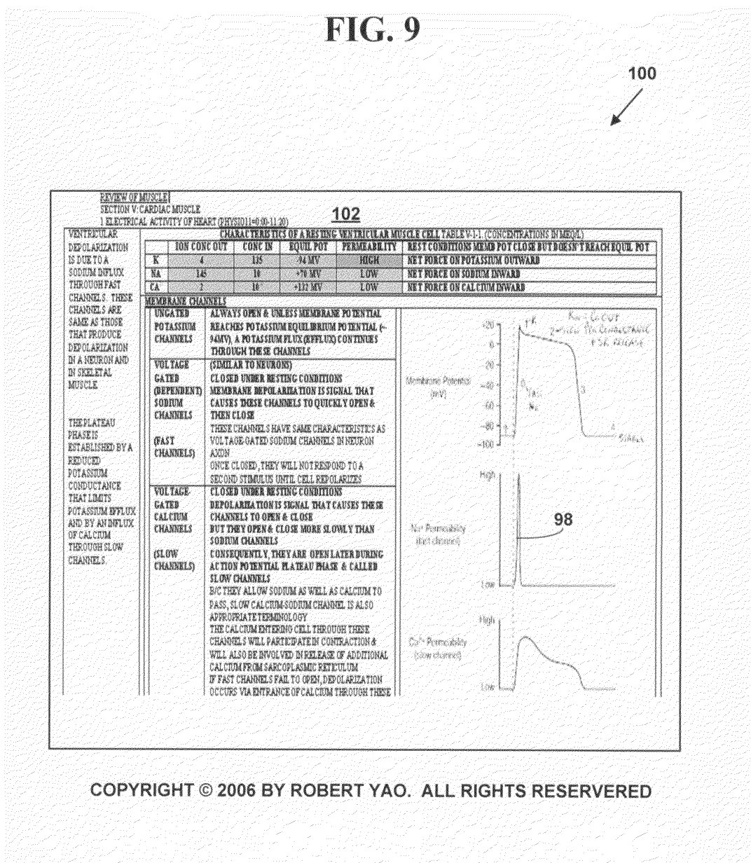

In this example, a physician who has a patient symptom related to cardiac channels 98 can enter a selection input and receive additional information as is illustrated in FIG. 9.

FIG. 9 is block diagram 100 illustrating a fourth set of health information related to cardiology 102. This set of information includes additional information on cardiac channels 98. This is one of the most detailed and “zoomed in” description of heart electrophysiology. In this example, the information displayed on this output screen is at a level X+3 in the information hierarchy.

FIGS. 6-9 illustrate different levels in an information hierarchy stored in a universal health information template. A user is able to switch between levels in the information hierarchy with selection inputs such as mouse clicks or keyboard inputs.

If the user selected different boxes than those described above, FIGS. 6-9 would display different output screens. The screen outputs displayed are a result of the selection inputs received.

Various levels in the information hierarchy include a graphical “medical Rosetta Stone.” As is known in the art, the original “Rosetta Stone” was a black basalt stone monument found in Egypt in 1799, which included the same message in three different languages including Greek, a script language and a hieroglyphic language. The Greek language, which was well known, enabled linguists to decode and understand the other two languages, which were not well known.

The medical Rosetta stone allows “translations” between various types of medical information including embroyologic, genetic, anatomical, histological, physiological, biochemical, clinical, and pharmacological pathways, diseases, symptoms, patient medical conditions another types of medical information. The medical Rosetta Stone allows a user to hover over and select a selected portion of the medical Rosetta to link a user to different types of associated information.

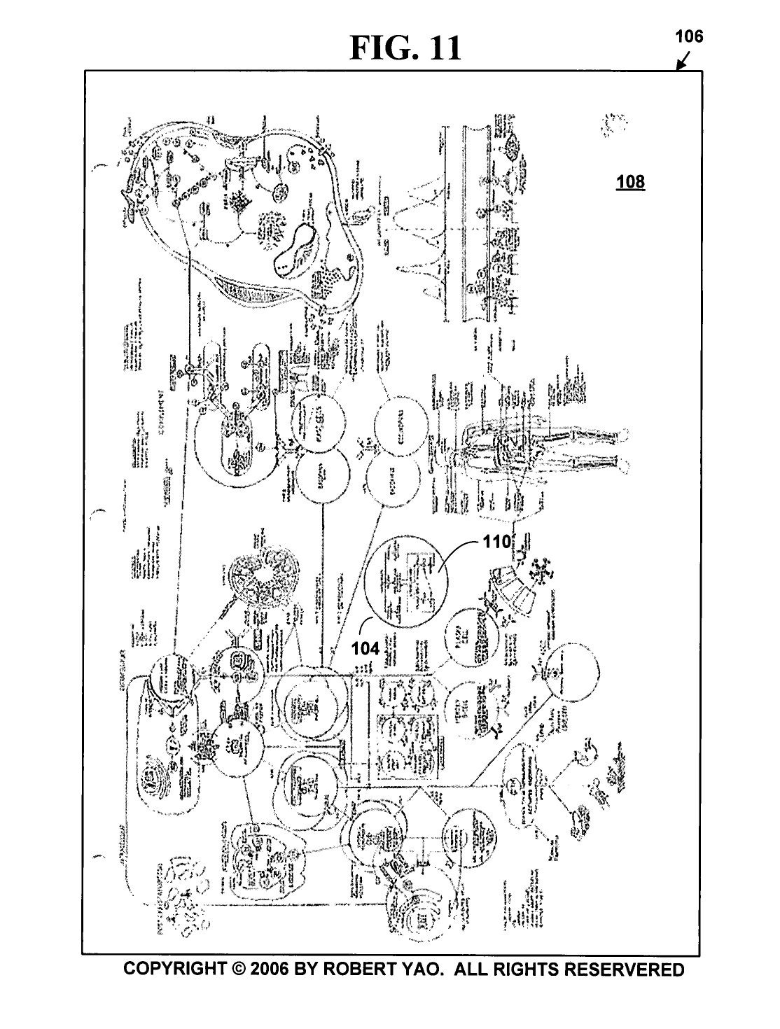

In one embodiment, the medical Rosetta Stone that has at least five sides Within a same side there are layers of any of the biological sciences, yet the overall diagram has a focus such as immunology or biochemistry (i.e., a micro Rosetta Stone layered within one side of the macro Rosetta Stone). Also within the one side there is a medical “compass rose” that orients the user to an overall picture of the information topic. In FIG. 11, an exemplary compass rose is illustrated as a circle 104 in the middle of the picture of the medical Rosetta Stone 104.

The block diagrams illustrated in FIGS. 6-9 are exemplary only and are used to illustrate how system 10 is used to change levels in the hierarchy and displays different types of information depending on the one or more filters selected. Each of the items in FIGS. 6-9 can be selected to obtain additional information in different layers of the information hierarchy. System 10 displays each of the items in FIGS. 6-9 in multiple colors. Colors are used and can be used to display sets of information based on the type of filters selected.

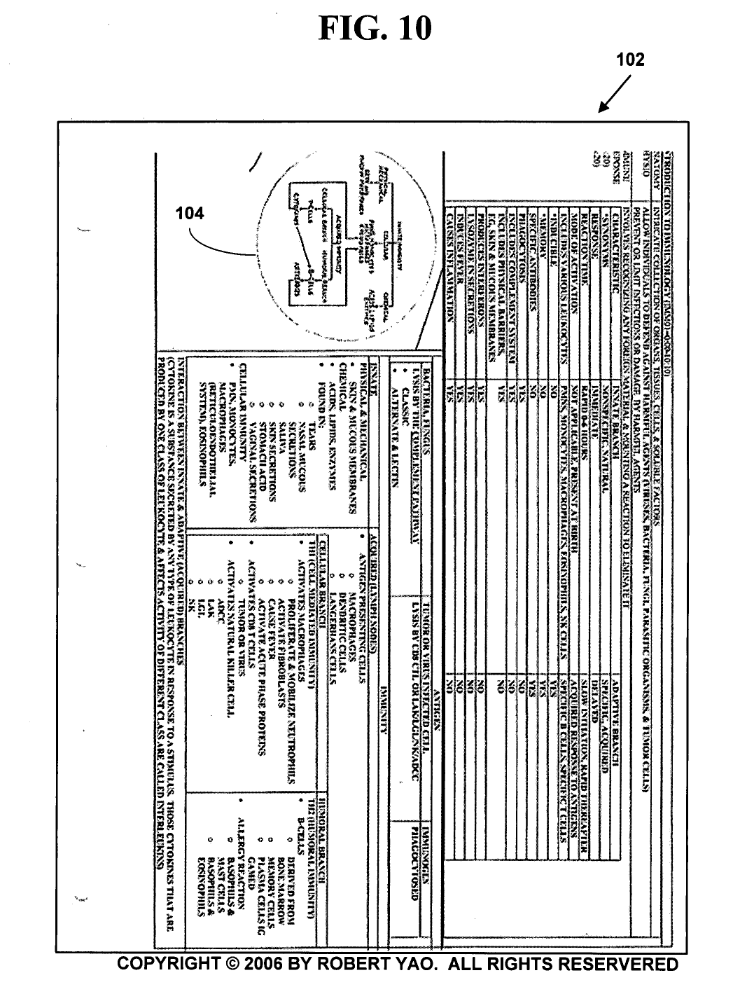

FIG. 10 is a block diagram 102 illustrating exemplary immunology information. The immunology information includes exemplary “medical Rosetta stone” compass rose 104 located on one side of the entire “medical Rosetta stone.” FIG. 10 is the zoom in on the “compass rose” complete with full explanation of the diagram in text as well as audio and in other examples possibly video or animations. Zooming into any other part in the diagram will show that portion of the medical Rosetta stone with explanations.

FIG. 11 is a block diagram 106 illustrating immunology pathways 108. The immunology pathways include the medical Rosetta Stone 104 for guiding a user to the appropriate associated information.

FIG. 10 is one example of a screen output displayed when a user uses “zoom in,” feature of the medical Rosetta Stone 104, specifically, the zoom in of the compass rose. In FIG. 11, the “compass rose” is the circle 104 in the middle of the picture. In the biochemistry diagram it is in the lower left corner 104.

For example, if a user hovered over an antibodies portion 110 of the medical Rosetta stone 104, antibody information in the immunology pathways 108 is highlighted for a user in a pre-determined color. A user can input a selection input and be linked to information associated with antibodies 110 in the information hierarchy.

### Displaying Medical Information for a Patient

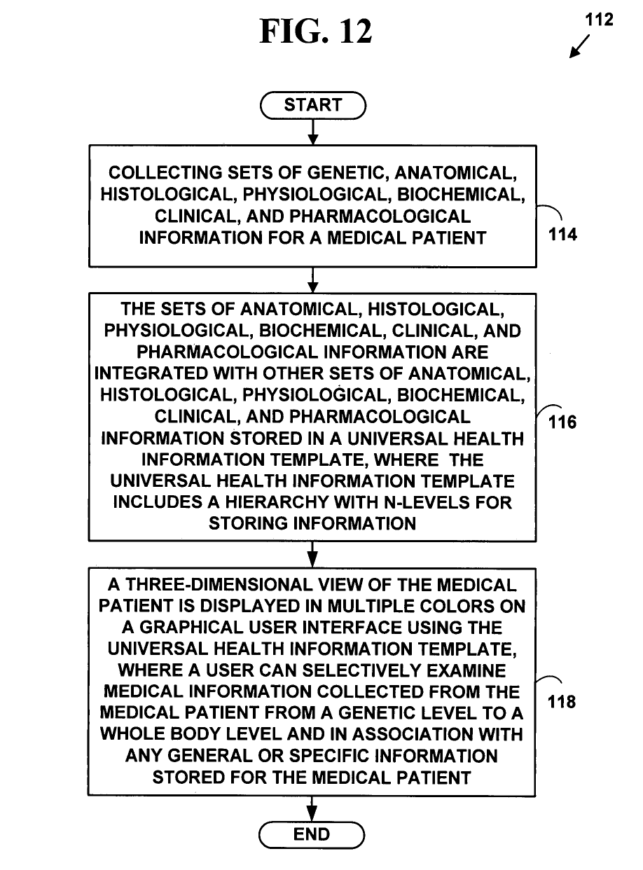

FIG. 12 is a flow diagram illustrating a Method 112 for displaying medical information. At Step 114, sets of genetic, anatomical, histological, physiological, biochemical, clinical, and pharmacological information are collected for a medical patient. These sets of medical information include collecting medical history, results of medical examinations, results of medical laboratory tests and other types of medical information for a human patient. At Step 116, the sets of anatomical, histological, physiological, biochemical, clinical, and pharmacological information are integrated with other sets of anatomical, histological, physiological, biochemical, clinical, and pharmacological information stored in a universal health information template. The universal health information template includes a hierarchy with N-levels for storing information. At Step 118, a three-dimensional view of the medical patient is displayed from the universal health information template in multiple colors on a graphical user interface. A user can selectively examine medical information collected from the medical patent from a genetic level to a whole body level and in association with any general or specific information stored in the universal health information template.

Method 112 is illustrative with an exemplary embodiment. However, the present invention is not limited to such an embodiment and other embodiments can also be used to practice the invention.

In such an exemplary embodiment at Step 114, sets of genetic, anatomical, histological, physiological, biochemical, clinical, and pharmacological information are collected for a human medical patient. These sets of medical information include collecting medical history, results of medical examinations, results of medical laboratory tests and other types of medical information for a human medical patient.

In one embodiment, a population's patient data into a database 20′ 22′ 24′ one patient at a time and to create a composite “picture” of what a particular disease would look like. This composite is then filtered based on selected variables such as individual patient, or in those with the same diagnosis, the types of symptoms and organs or systems affected. This in turn is used to on previously undiagnosed new patients with unknown conditions by comparing percentage-wise across a differential which diagnosis fits best Individual data is collected to create a composite then used as percentages to classify any new individuals entered into the databases 20′ 22′, 24′ based on percentage similarities and differences.

In another embodiment, the stored data is used for comparing various individual members of the same genus based on specific variables and using the variables to classify the species based on similarities or differences in the variables, etc.

At Step 116, the sets of anatomical, histological, physiological, biochemical, clinical, and pharmacological information are integrated with other sets of anatomical, histological, physiological, biochemical, clinical, and pharmacological information stored in a universal health information template 34. The universal health information template 34 includes a hierarchy with N-levels for storing information.

At Step 118, a 3D view of the medical patient is displayed from the universal health information template in multiple colors on the GUI 32. A user can selectively examine medical information collected from the medical patent from a genetic level to a whole body level and in association with any general or specific information stored for the medical patient. In one embodiment, the 3D view includes a full 3D body view of a specific medical patient where a user can select obtain specific information collected for the medical patient or general information about an associated medical area or medical system.

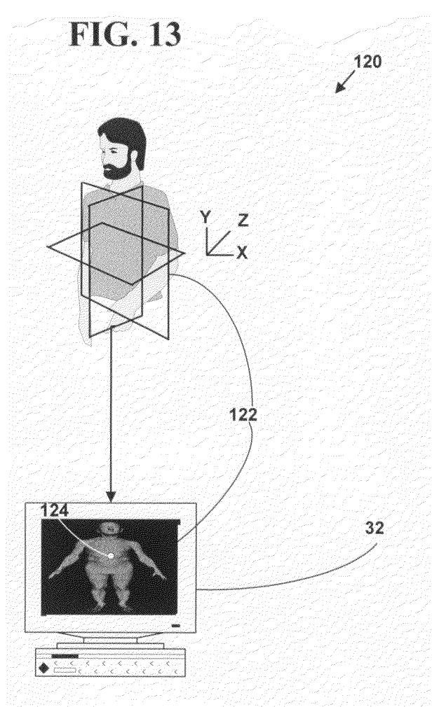

FIGS. 13-16 illustrate exemplary screen output displayed on GUI 32 from using the methods and system described herein. As an example, assume an exemplary patient who is 58 years old for which medical information has been previously collected and stored visits an emergency room with chest pains. The patient has had a previous history of chest pains and has an elevated cholesterol level for which he is taking cholesterol lowering drugs and also suffers from coronary artery narrowing. The emergency room physician desire to determine a treatment for the patient that may include new or additional medication using the methods and system described herein.

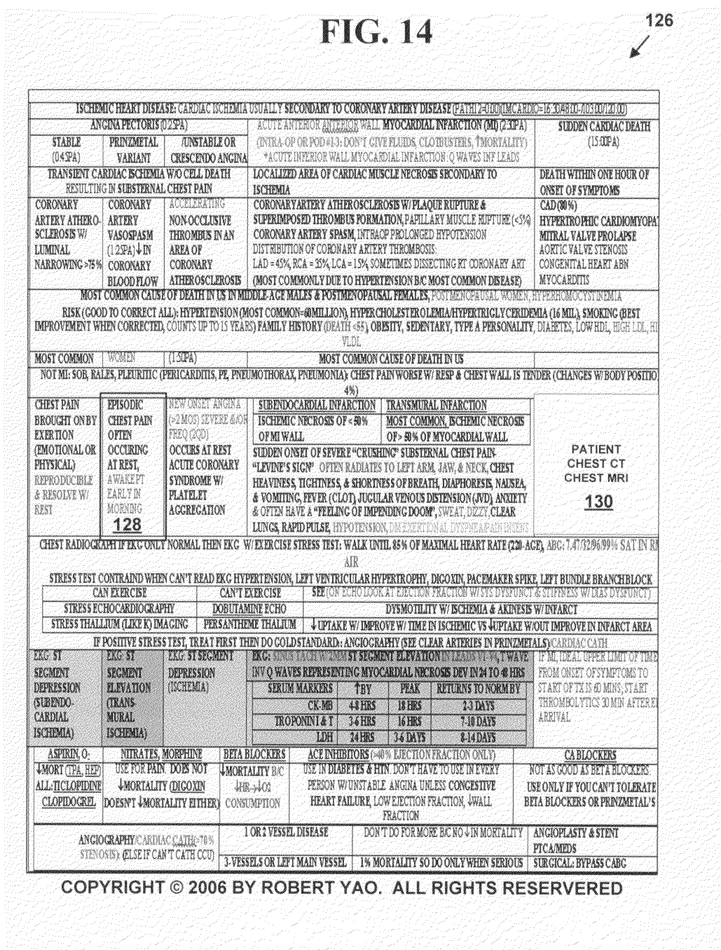

FIG. 13 is a block diagram 120 illustrating an exemplary 3D view 122 of an exemplary patient on GUI 32. FIG. 13 illustrates an exemplary selection point 124 for cardiac information for the exemplary patient. For simplicity on the drawing, only one selection point is illustrated. However, the 3D view of the medical patient typically includes tens to hundreds to thousands of selection points for other medical information collected for the patient including genetic, etc. Selecting this selection point produces the actual screen output illustrated in FIG. 14.

FIG. 14 is a block diagram 126 illustrating exemplary additional cardiology information at a lower level-X in the information hierarchy obtained via selection point 124 on the GUI 32. The actual screen output illustrates medical information for “ischemic heart disease.” The emergency room doctor is able to review all the presented information and choose the box most appropriate for the patient symptoms (e.g., 128). There are also links (e.g., box 130) to patient information (e.g., 90, 92 of FIG. 7).

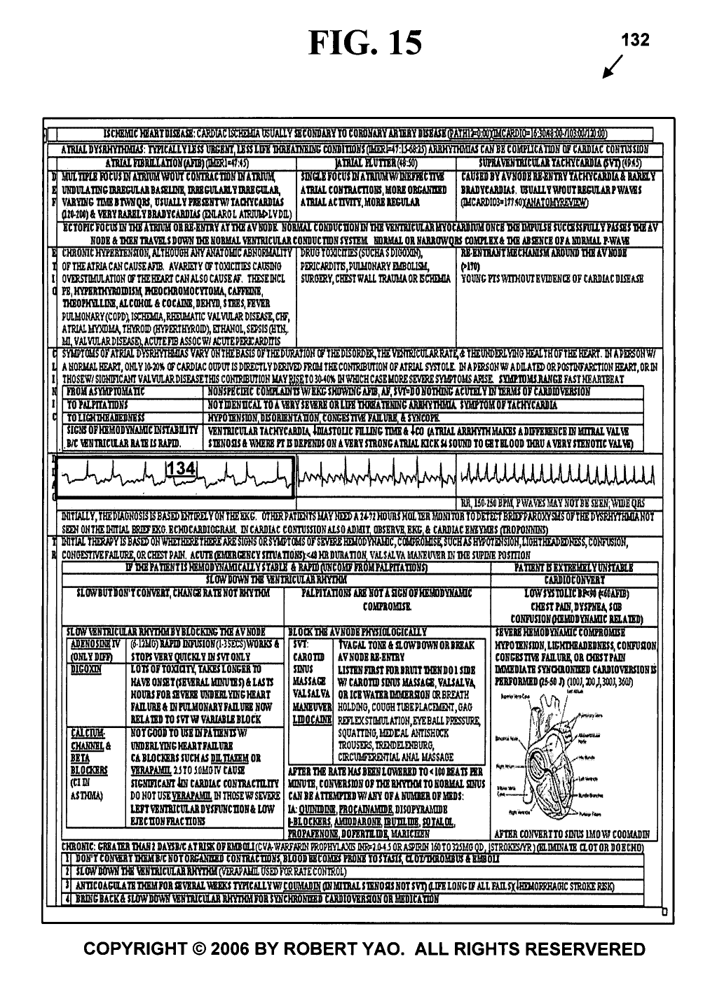

In this example, the emergency room doctor reviews the output and selects box 128 for “episodic chest pain often occurring at rest.” Selecting this box produces the actual screen output illustrated in FIG. 15.

FIG. 15 is a block diagram 132 illustrating exemplary additional cardiology information at a lower level-X+1 in the information hierarchy obtained via selection point 128 of FIG. 14.

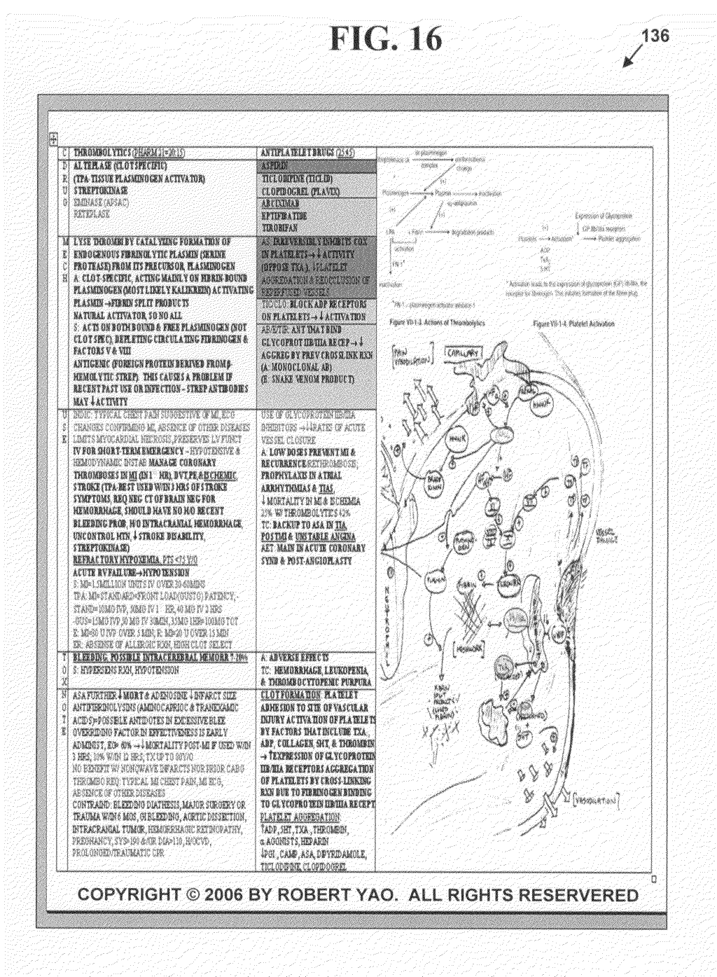

In this example, the emergency room doctor reviews the output and selects box 134 for a diagnosis based on an EKG currently collected for the patient. Selecting this box produces the screen output illustrated in FIG. 16.

FIG. 16 is a block diagram 136 illustrating exemplary additional cardiology information at a lower level-X+2 in the information hierarchy obtained via selection point 134 of FIG. 15.

In this example, the emergency room doctor is able to review available drugs and their potential interaction with the cholesterol lowering drugs the patient is already taking. Box 136 includes diagrams for actions of thrombolytics and platelet activation drugs.

Selecting other boxes would display other types of information at other levels in the information hierarchy.

The methods and system described herein include an “assembly line for collecting and storing then categorizing/classifying and connecting various forms of information, specifically but not limited to biologic (zoologic, embryologic, genetic, anatomical, histological, physiological, biochemical, immunologic, neurologic, etc.) or associated health information in the categories listed in biologic as they relate to clinical uses (in medical subspecialties: obstetric, pediatric, medical/internal medicine, surgical, family practice, psychiatric, infectious disease, rheumatologic, pharmacologic, etc). The methods and system described herein are used to create an operating system for medical and other information using the organism itself as the GUI to obtain biologic, medical and health information as a educational and reference tool in the classification and diagnosis of the organism or disease affecting that organism.

The assembly line method can also be used to provide updates specific to particular sections in anything that is structured in a similar template/matrix/tabular format. Medical and biologic classifications are variables themselves along with the corresponding information contained in them. So that the same method can be used to update or upgrade specific portions in programs, databases, matrices, tables in textbooks or computer programs for any subject.

The methods and system described herein are used for creating an assembly line of information that is used as an operating system for medical and health information. Individual pieces of information in the assembly line of information can be selectively collected and categorized then can be selected, mined and displayed using various filters as was described above. The method and system can be used for collecting, storing, organizing and displaying biological information about human and non-human biological organisms.

It should be understood that the architecture, programs, processes, methods and systems described herein are not related or limited to any particular type of computer or network system (hardware or software), unless indicated otherwise. Various types of general purpose or specialized computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments hardware or firmware implementations may alternatively be used, and vice-versa.

The claims should not be read as limited to the described order or elements unless stated to that effect. In addition, use of the term “means” in any claim is intended to invoke 35 U.S.C. §112, paragraph 6, and any claim without the word “means” is not so intended.

Therefore, all embodiments that come within the scope and spirit of the following claims and equivalents thereto are claimed as the invention.

I claim:

1. A method for organizing health information, comprising:
collecting sets of genetic, anatomical, histological, physiological, biochemical, clinical, and pharmacological information for a pre-determined biological organism;
storing the collected sets of genetic, anatomical, histological, physiological, biochemical, clinical, and pharmacological information in a universal health information template, wherein the universal health information template includes a hierarchy with N-levels for storing information; and
selectively displaying hierarchical information components about the pre-determined biological organism in multiple colors on a graphical user interface by applying one or more filters to the hierarchical information stored in the universal health information template,
wherein selected ones of the hierarchical information components are displayed in a first set of highlight colors on the graphical user interface to display a primary set of information based on the one or more applied filters and wherein other selected ones of the hierarchical information are displayed in a second set of non-highlight colors on the graphical user interface to simultaneously display a secondary set of information based on the one or more applied filters.

2. The method of claim 1 further comprising a computer readable medium having stored therein instructions for causing one or more processors to execute the steps of the method.

3. The method of claim 1 wherein the pre-determined biological organism is a human or a non-human biological organism.

4. The method of claim 1 wherein the collecting step includes collecting sets of genetic, anatomical, histological, physiological, biochemical, clinical, and pharmacological information for a specific human being determined during medical examinations and medical laboratory tests conducted on the specific human being.

5. The method of claim 1 wherein the one or more filters include one or more filters for displaying a selected type of information, a current medical condition, a selected type of information based on a prior knowledge level, a current set of medical records for a patient or a pre-determined logic association.

6. The method of claim 1 wherein the universal health information template includes defining a kingdom, phylum, class, order, family and genus of health information at a level-X in a hierarchical structure with N-layers, defining an genetic, anatomical, histological, physiological, biochemical, clinical, and pharmacological information at a level X+1 to level X+Y and defining a set of pre-defined set of plural colors for displaying the health information on a multi-windowed graphical user interface (GUI) at a level Y+1.

7. The method of claim 1 wherein the universal health information template includes information used as a teaching tool to teach medical students, or other medical professionals including doctors, nurses, pharmacists or physical therapists.

8. The method of claim 1 wherein the universal health information template includes information used to diagnose a current medical condition for a medical patient.

9. The method of claim 1 wherein the universal health information template includes information used to review current medical records for a medical patient.

10. The method of claim 1 wherein the universal health information template includes information for a physician to review current medical information for a selected area of medicine or for a selected medical condition.

11. The method of claim 10 wherein the selected area of medicine includes genetic, anatomical, histological, physiological, biochemical, clinical, and pharmacological information for embryologic, obstetric, pediatric, gynecologic, psychiatric or nuerologic areas of medicine.

12. The method of claim 1 wherein the displaying step includes displaying a medical Rosetta stone that allows translations between various types of medical information stored in the hierarchy, wherein the medical Rosetta stone includes a compass rose within the medical Rosetta stone.

13. The method of claim 12 wherein the medical Rosetta stone is a graphical object including compass rose within the medical Rosetta stone including a plurality of selectable electronic links to other information stored in the universal health information template.

14. A method for displaying health information, comprising:
selecting one or more filters are selected from plural filters on a target device used to display health information with information stored in a universal health information template, wherein the universal health information template includes a hierarchy with N-levels for storing information;
receiving on a target device a first set of health information based on the one or more selected filters; and
inputting one or more selection inputs on the target device to receive other sets of health information at different levels in the hierarchy of the universal health template, wherein a user can selectively examine medical information collected from the medical patient from a genetic level to a whole body level and in association with any general or specific information stored for the medical patient.

15. The method of claim 14 further comprising a computer readable medium having stored therein instructions for causing one or more processors to execute the steps of the method.

16. The method of claim 14 wherein the universal health information template includes defining a kingdom, phylum, class, order, family and genus of health information at a level-X in a hierarchical structure with N-layers, defining an genetic, anatomical, histological, physiological, biochemical, clinical, and pharmacological information at a level X+1 to level X+Y and defining a set of pre-defined set of plural colors for displaying the health information on a multi-windowed graphical user interface (GUI) at a level Y+1.

17. The method of claim 14 wherein the one or more filters include one or more filters for displaying a selected type of information, a current medical condition, a selected type of information based on a prior knowledge level, a current set of medical records for a patient or a pre-determined logic association.

18. The method of claim 14 wherein the inputting step includes inputting one or more selection inputs into a medical Rosetta stone that allows translations between various types of medical information stored in the hierarchy.

19. A method for displaying medical information for patient, comprising:
collecting sets of genetic, anatomical, histological, physiological, biochemical, clinical, and pharmacological information for a medical patient, wherein the sets of medical information include collecting medical history, results of medical examinations, results of medical laboratory tests and other types of medical information for a human patient;
storing the sets of anatomical, histological, physiological, biochemical, clinical, and pharmacological information are integrated with other sets of anatomical, histological, physiological, biochemical, clinical, and pharmacological information in a universal health information template, wherein the universal health information template includes a hierarchy with N-levels for storing information; and
displaying a three-dimensional view of the medical patient from the universal health information template in multiple colors on a graphical user interface, wherein a user can selectively examine medical information collected from the medical patent from a genetic level to a whole body level and in association with any general or specific information stored in the universal health information template.

20. The method of claim 19 further comprising a computer readable medium having stored therein instructions for causing one or more processors to execute the steps of the method.

21. A system for organizing and displaying health information, comprising in combination:
means for collecting sets of genetic, anatomical, histological, physiological, biochemical, clinical, and pharmacological information for a pre-determined biological organism and for storing the collected sets of genetic, anatomical, histological, physiological, biochemical, clinical, and pharmacological information in a universal health information template, wherein the universal health information template includes a hierarchy with N-levels for storing information;
means for selecting one or more filters are selected from plural filters to display health information with information stored in the universal health information template;
means for selectively displaying hierarchical information components in multiple colors on a graphical user interface by applying one or more filters to the hierarchical information stored in the universal health information template,
wherein selected ones of the hierarchical information components are displayed in a first set of highlight colors on the graphical user interface to display a primary set of information based on the one or more applied filters and wherein other selected ones of the hierarchical information are displayed in a second set of non-highlight colors on the graphical user interface to simultaneously display a secondary set of information based on the one or more applied filters.

22. The system of claim 21 further comprising a graphical medical Rosetta stone means including a compass rose means within the graphical medical Rosetta stone means including a plurality of selectable electronic links to other information stored in the universal health information template.

23. The system of claim 21 further comprising means for displaying a three-dimensional view of a medical patient from the universal health information template in multiple colors on a graphical user interface, wherein a user can selectively examine medical information collected from the medical patent from a genetic level to a whole body level and in association with any general or specific information stored in the universal health information template.
